(19) United States
(12) Patent Application Publication
(10) Pub. No.: US 2006/0276946 A1
(43) Pub. Date: Dec. 7, 2006

(54) Discrimination apparatus

(75) Inventors: Norio Kaneko, Atsugi-Shi (JP); Takehiko Kawasaki, Atsugi-Shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/442,351

(22) Filed: May 30, 2006

(30) Foreign Application Priority Data
Jun. 6, 2005 (JP) 2005-165795

(51) Int. Cl. G06F 17/00

(52) U.S. Cl. 701/45

(57) ABSTRACT

Provided is a discrimination apparatus including: an impact application unit for applying an impact to an object to be discriminated; a signal output unit for outputting a signal corresponding to an impact applied by the impact application unit; a discrimination unit for discriminating the object to be discriminated on basis of the signal from the signal output unit; and a pressure-receiving position correction member having a pressure-receiving part for receiving an impact force applied by the impact application unit, and an action part for acting the impact force received at the pressure-receiving part on a predetermined site of the signal output unit.

### BACKGROUND OF THE INVENTION

1. Field of the Invention

The present invention relates to a discrimination apparatus for applying an impact to an object to be discriminated to discriminate the object to be discriminated on the basis of an output signal corresponding to the impact application.

2. Related Background Art

Japanese Patent No. 3658382 has proposed a technique of discriminating a kind of object to be discriminated, in which an impact application means applies an impact to an object to be discriminated, a signal output means outputs a signal corresponding to the impact, and a discrimination means detects the kind of object to be discriminated on the basis of the signal from the signal output means.

The above technique can be used for an image forming apparatus such as an ink jet printer, a laser beam printer, or a copying machine. For example, in the image forming apparatus, the above technique can be used for discriminating a kind of sheet material which is an object to be discriminated and utilizing its discrimination result for controlling the image formation (for example, controlling an amount of ink ejection, a fixing temperature, or a conveying speed). Also, for example, in the ink jet printer, the above technique can be also used for discriminating a status of a liquid container in which an ink is encapsulated. The above discrimination apparatus is not limited to use for discriminating the above sheet material or the liquid container, but can be also effectively used as an discrimination apparatus for discriminating various substances, that is, an organic matter and an inorganic matter such as a metal, an alloy, a plastic, or a ceramic, and compounds thereof and molded products thereof.

Incidentally, in the above discrimination apparatus, it is possible to use, for example, a piezoelectric element as the signal output means. However, when a position at which a force is applied to the signal output means is different, even if the same force is applied, how to generate a shear force or a deflection stress by the signal output means is different. That is, a difference occurs in the output signal, which causes a lack of precision.

However, the impact application means does not always accurately apply the impact to the same position due to, for example, degradation with elapse of time or the error of respective components. Also, there is a fear that the position at which the force is applied to the signal output means is different due to a shape or a located position of the object to be discriminated.

Also, in particular, in a case where the impact application means and the signal output means are structured separately, an assembling error may occur when the impact application means and the signal output means are assembled as the discrimination apparatus. For example, in the image forming apparatus, there is a case in which the impact application means and the signal output means are arranged in a positional relationship which is different in each of the discrimination apparatuses (each of the image forming apparatuses) due to the assembling error because the impact application means and the signal output means are separately assembled at opposite positions with the interposition of a transportation path of the sheet material. In the case of outputting a signal that is different in each of the discrimination apparatus as described above, it is necessary to prepare, depending on the individual errors of the respective discrimination apparatuses, reference data to be compared with the signal in order to discriminate the object to be discriminated. Such a countermeasure is difficult to be performed at the time of manufacturing because of a limit of manufacturing costs. On the contrary, when an influence of the assembling error is ignored, and the same reference data is applied to all of the discrimination apparatuses, an discrimination error may occur.

### SUMMARY OF THE INVENTION

In view of the above circumstances, an object of the present invention is to provide a discrimination apparatus capable of acting a force received corresponding to an applied force of the impact-applying unit on a predetermined site of a signal output unit.

To solve the above-mentioned problems, according to one aspect of the present invention, a discrimination apparatus includes: an impact-applying unit for applying an impact to an object to be discriminated; a signal output unit for outputting a signal corresponding to an impact applied by the impact-applying unit; a discrimination unit for discriminating the object to be discriminated on a basis of the signal from the signal output unit; and a pressure-receiving position correction member including a pressure-receiving part for receiving an impact force applied by the impact-applying unit, and an action part for acting the impact force received at the pressure-receiving part on a predetermined site of the signal output unit, the action part having an area smaller than an area of the pressure-receiving part.

Further, according to another aspect of the present invention, a signal output apparatus for outputting a signal corresponding to impact application includes: a piezoelectric element; a pressure-receiving part for receiving an impact force; and an action part for acting a force received at the pressure-receiving part on the piezoelectric element, the action part having an area smaller than an area of the pressure-receiving part.

### BRIEF DESCRIPTION OF THE DRAWINGS

FIG. 1 is a schematic structural diagram showing a discrimination apparatus;

FIG. 2 is a flowchart showing a discrimination steps;

FIG. 3 is a structural diagram showing an impact-applying unit according to Embodiment 1;

FIG. 4 is a structural diagram showing an impact force detection unit according to Embodiment 1;

FIGS. 5A and 5B are diagrams showing relationships between an impact-applying position and a generated voltage, FIG. 5A is a diagram in a case of directly applying an impact force to a piezoelectric element, and FIG. 5B is a diagram in a case of applying the impact force to the piezoelectric element through a pressure-receiving position correction member;

FIG. 6 is a timing chart showing an example of the generated voltage of a piezoelectric element at the time of applying the impact;

FIG. 7 is a diagram showing an example of a determination table according to Embodiment 1;

FIG. 8 is a structural diagram showing a discrimination apparatus according to Embodiment 2; and

FIG. 9 is a diagram showing a relationship between densities of respective sheet materials and relatively generated voltages from a piezoelectric element.

### DETAILED DESCRIPTION OF THE EMBODIMENTS

Now, a description will be given in more detail of embodiments with reference to the accompanying drawings.

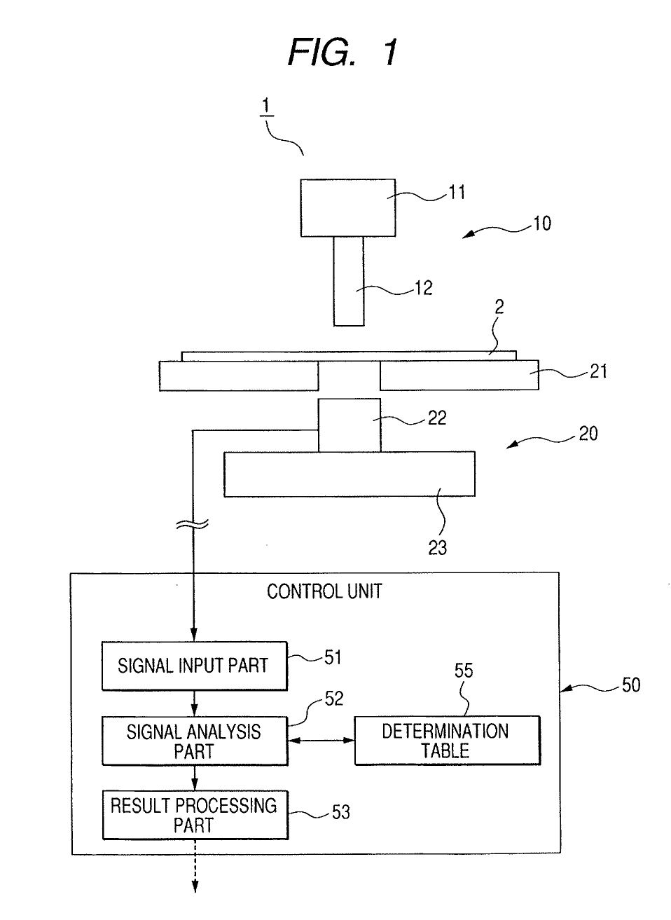

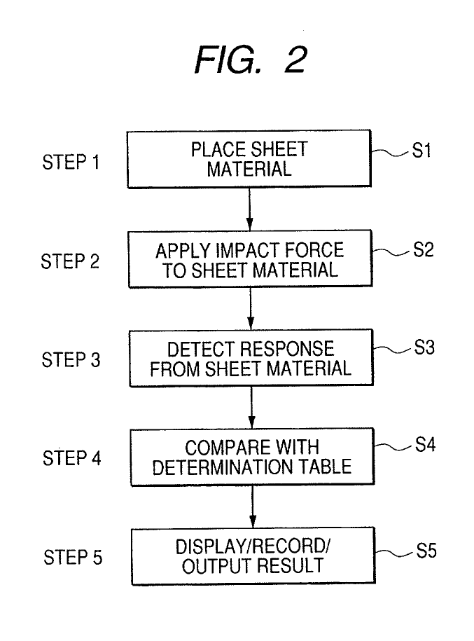

First, a basic structure and principle of a discrimination apparatus according to the present invention will be briefly described with reference to FIGS. 1 and 2. FIG. 1 is a schematic structural diagram showing the discrimination apparatus. FIG. 2 is a flowchart showing discrimination steps. In this embodiment, for facilitating understanding of the present invention, a description will be given of an example in which the discrimination apparatus is disposed in an image forming apparatus such as a printer, and the discrimination apparatus discriminates a kind of sheet material which is an object to be discriminated. However, the present invention is not limited to this example.

The discrimination apparatus 1 is disposed in the vicinity of a transportation path for transporting a sheet material 2 between a sheet material supply unit (not shown) such as a manual tray or a paper feeder cassette of an image forming apparatus, and an image forming unit (for example, a transfer drum, or an ink jet head). As shown in FIG. 1, the discrimination apparatus 1 includes an impact-applying unit (impact application means) 10, an impact force detection unit 20, and a control unit (discrimination unit) 50 serving as a discrimination unit. The impact-applying unit 10 and the impact force detection unit 20 are disposed opposite to each other with interposition of the transportation path for the sheet material. The control unit 50 may be disposed anywhere, for example, within the control unit of the image forming apparatus or in the vicinity of the impact force detection unit 20.

The impact-applying part 10 includes an impact-applying member 12, and a driver device 11 for driving the impact-applying member 12 so that the impact-applying member 12 generates the impact application. Also, the impact force detection unit 20 is composed of a signal output part 22 for outputting a signal (for example, a voltage signal, an acoustic wave signal, or an infrared signal) corresponding to the impact force when receiving the impact force, a signal output part installation table 23, and a hole into which the signal output part 22 is installed. The impact-applying unit 10 also includes a sheet material installation table 21 on which the sheet material 2 may be set. The sheet material installation table 21 may be replaced with a sheet guide member (for example, guide rails) that is disposed in the image forming apparatus, and may not be always installed within the discrimination apparatus 1.

The control unit 50 includes a signal output part 51, a signal analysis part 52, a determination table 55, and a result processing part 53. The signal input part 51 inputs (receives) a signal from the signal output part 22. Also, the determination table 55 stores reference data (reference information) for each of the kinds of sheet materials therein in advance. The signal analysis part 52 discriminates the kind of sheet materials on the basis of a signal that has been inputted to the signal input part 51 while referring to the reference data of the determination table 55. Then, the result processing part 53 conducts such result processing as to transmit the discrimination result of the kind of sheet material by the signal analysis part 52 to, for example, the control unit of the image forming apparatus. The result processing part 53 is capable of recording the result on, for example, recording means or displaying the result through a display device in addition to the transmission of the result. In addition, the result processing part 53 is capable of conducting various result processes so as to reflect (learn) the result in the determination table 55, or transferring the result through the Internet.

In the case of determining the kind of sheet material 2 by using the discrimination apparatus 1, the sheet material 2 is first placed on the sheet material installation table 21 (Step 1, S1) as shown in FIG. 2. In this situation, the sheet material 2 not need to stop and may be transported in the image forming apparatus. Then, the impact-applying member 12 is driven by the impact-applying unit 10 to apply an impact force to the sheet material 2 (Step 2, S2). The impact force causes the sheet material 2 to be deformed, pushed against the impact force detection means while being bent, and deformed under the compression. In this situation, the impact force that is applied from the impact force-applying unit 10 is detected by the signal output part 22 which is attached onto the signal output part installation table 23 while the impact force is absorbed by the sheet material 2, and a signal is outputted from the signal output part 22 (Step 3, S3) Because the applied impact force is propagated in the sheet material 2 in a different state due to the kind of sheet material 2, a unique signal of the respective sheet materials is outputted from the signal output part 22. Accordingly, information on the sheet material 2 whose characteristics have been known in advance is prepared as a determination table 55, thereby making it possible to discriminate the kind of sheet material 2 by comparing the determination table 55 with the signal through the signal analysis part 52 (Step 4, S4). This result is displayed, recorded on a memory, or outputted by the result processing part 53 if necessary, thereby making it possible to use the discrimination result (Step 5, S5).

### Embodiment 1

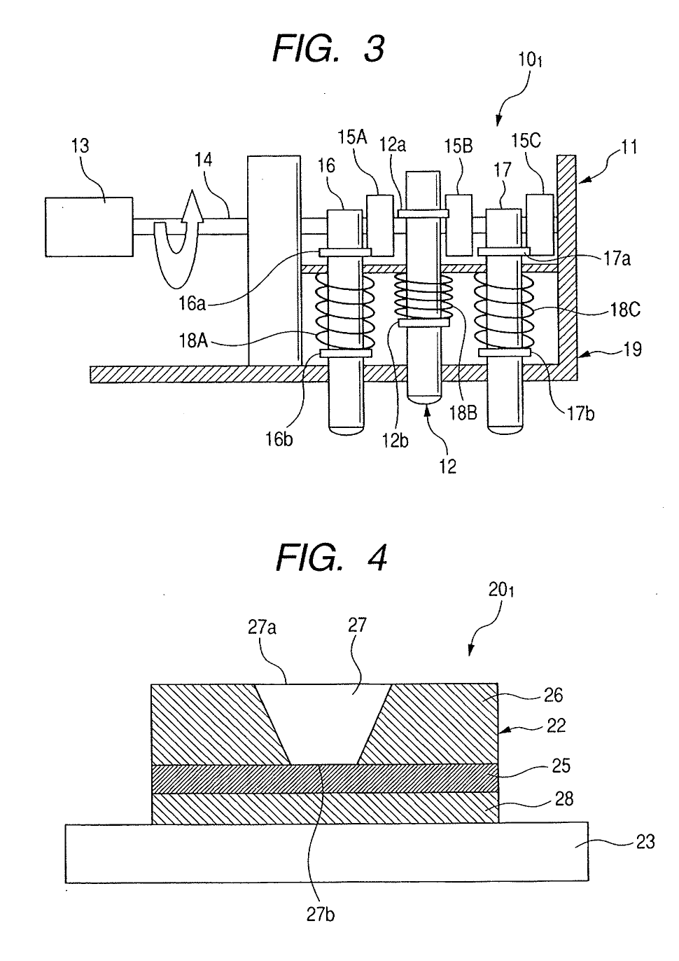

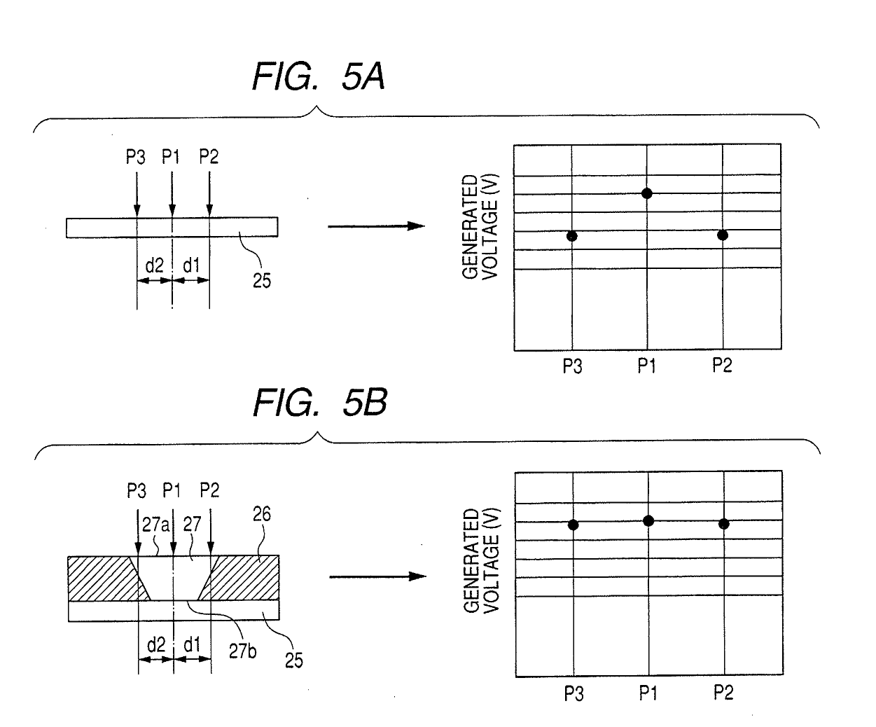

Now, a description will be given of Embodiment 1 according to the present invention with reference to FIGS. 3 to 5B. FIG. 3 is a structural diagram showing an impact application unit according to Embodiment 1, FIG. 4 is a structural diagram showing an impact force detection unit according to Embodiment 1, and FIGS. 5A and 5B are diagrams showing relationships between an impact-applying position and a generated voltage. FIG. 5A is a diagram in the case of directly applying an impact force to a piezoelectric element as a mechano-electrical transducer, and FIG. 5B is a diagram in the case of applying the impact force to the piezoelectric element through a pressure-receiving position correction member.

As shown in FIG. 3, a driving device 11 of an impact application unit 101 according to this embodiment is equipped with a motor 13, and a driving shaft 14 that is rotatably driven by the motor 13 is rotatably supported by a main body 19. Also, the driving shaft 14 is fixed with cams 15A, 15B, and 15C. On the other hand, the main body 19 has an impact-applying member 12 and two pressing members 16 and 17 movably supported in a vertical direction. In addition, the impact-applying member 12 and the pressing members 16 and 17 are always urged downward by springs 18A, 18B, and 18C that are compressed by the respective flange parts 12b, 16b, and 17b. Then, the impact-applying member 12 and the pressing members 16 and 17 are so formed as to be driven upward by engaging the respective flange parts 12b, 16b, and 17b with the cams 15A, 15B, and 15C.

The shape and the attaching angle of the cams 15A, 15B and 15C are determined in such a manner that the impact-applying member 12 is released by the cam 15B to apply an impact in a state where the pressing members 16 and 17 press both sides of the sheet material 2 (refer to FIG. 1). Also, the shape of the cam 15B is formed such that positions at which the impact-applying member 12 is driven upward are different at two stages, that is, different impact forces can be applied.

The impact-applying member 12 is made of a member having a low elastic coefficient such as stainless steel. Also, the strength of the impact force, and the number of times or timing of impact force applications can be arbitrarily set by the structures of the cams, the springs, and the impact-applying member 12. In this embodiment, for example, the impact force is applied twice within 0.1 seconds, and the strength of the impact force is changed at two stages.

On the other hand, as shown in FIG. 4, an impact force detection unit 20, according to this embodiment has a signal output part 22 fixed and placed onto the signal output part installation table 23 by, for example, an adhesive. The signal output part 22 is composed of a viscoelastic member 28 located on the signal output part installation table 23, a piezoelectric element 25 fixed to the viscoelastic member 28, a viscoelastic member (side support member) 26 fixed on the piezoelectric element 25, and a pressure-receiving position correction member 27.

The viscoelastic member 26 has a fitting hole formed in a shape into which the pressure-receiving position correction member 27 is fitted, and is shaped in a film. The pressure receiving position correction member 27 having a conical trapezoidal shape is located in the fitting hole. The pressure-receiving position correction member 27 has a lower surface 27b smaller in area than an upper surface 27a.

The pressure-receiving position correction member 27 is made of, for example, an elastic member such as stainless steel, and the viscoelastic members 26 and 28 are made of viscoelastic material such as silicone resin. The pressure-receiving position correction member 27 is made of a material that is small in loss elastic modulus E″ or loss tangent tan δ=E″/E′ when it is assumed that the complex elastic modulus E is set so as to establish E=E′+iE″. The viscoelastic members 26 and 28 may be made of the same material or different materials. In a case where the viscoelastic members 26 and 28 are made of the different materials, it is preferable that the viscoelastic member 26 be equal to or larger than the viscoelastic member 28 in the loss elastic modulus E″ or tan δ=E″/E′. It is preferable that the viscoelastic member 28 be interposed for protection of the piezoelectric element 25, but the piezoelectric element 25 may be located directly on the signal output part installation table 23.

When the piezoelectric element 25 detects the signal, the deflection of the piezoelectric element 25 is utilized in one case, and in another case, the compression of the piezoelectric element 25 is utilized. It is needless to say that both of the deflection and compression of the piezoelectric element 25 can be used, but the case of using the deflection is mainly exemplified in this description. In this case, it is desirable that an impact force be propagated to the center of the piezoelectric element 25 through the sheet material 2. For example, in a case where the piezoelectric element 25 (except for a leading wiring portion) is configured to have a width a (mm)×length b (mm)×height c (mm) (a>b>c), when a pressure is applied to a position deviated from the center of the piezoelectric element 25 widthwise and lengthwise, the output of the piezoelectric element 25 due to the deflection becomes smaller as the amount of deviation becomes larger.

However, when the impact force-applying unit 10₁ and the impact force detection unit 20₁ are so assembled together as to interpose a transportation path of the sheet material in, for example, a printer therebetween, there is a fear that the positional relationship between the impact force-applying unit 10₁ and the impact force detection unit 20₁ is slightly deviated due to the assembling error. That is, there is a fear that a product error occurs in each of the discrimination apparatuses 1. In this case, the output from the piezoelectric element is different in each of the discrimination apparatuses 1, and it is difficult to prepare the reference data of the determination table 55 in advance.

For that reason, according to the present invention, the pressure-receiving position correction member 27 is attached onto the center portion of the piezoelectric element 25, and the upper surface 27a opposite to the lower surface 27b is increased in area than the lower surface 27b that is in contact with the piezoelectric element 25. With the above structure, even if the impact force from the impact force-applying member 12 through the sheet material 2 is deviated from the center of the piezoelectric element 25, the impact force is efficiently propagated to the center portion of the piezoelectric element 25.

In other words, in fact, there is a case in which the centers of the piezoelectric elements 25 do not coincide with each other due to the assembling error of the discrimination apparatuses 1. For example, as shown in FIG. 5A, when the impact force is applied to the piezoelectric element 25 at positions P2 and P3 that are deviated from a center position P1 by distances d1 and d2 (for example, 2 mm) without arranging the pressure-receiving position correction member 27, the generated voltage from the piezoelectric element 25 is lowered, for example, by about 28%. On the other hand, in the present invention, as shown in FIG. 5B, since the pressure receiving position correction member 27 is provided, even if the impact force is applied to the piezoelectric element 25 at the positions P2 and P3 that are deviated from the center position P1 by the distances d1 and d2 (for example, 2 mm), the generated voltage is lowered only by about 2% at the maximum. Accordingly, it has been confirmed that the generated voltage from the piezoelectric element 25 is outputted with an extremely excellent reproducibility by the pressure-receiving position correction member 27 of the present invention even if the position to which the impact force is applied is deviated.

As described above, according to the present invention, even if a variation occurs in the position of the received force on the piezoelectric element by the impact application of the impact-applying unit 101, the impact force can be acted on a predetermined portion of the piezoelectric element 25 by the pressure-receiving position correction member 27. As a result, it is possible to improve a precision of the signal outputted from the piezoelectric element 25, and it is possible to improve a precision of the discrimination as the discrimination apparatus 1. Also, in particular, even if a slight error occurs at the positions where the impact-applying unit 10₁ and the impact force detection unit 20, are located when the discrimination apparatus 1 is assembled to the printer, it is possible to improve the precision of the signal outputted from the piezoelectric element 25. Accordingly, the discrimination precision as the discrimination apparatus 1 can be improved because the contents of the determination table 55 do not depend on the assembling error.

Also, since the viscoelastic member 26 supports the sides of the pressure receiving position correction member 27, the pressure-receiving position correction member 27 can be prevented from being tilted. In addition, since the transmission direction of the impact force is guided in a direction substantially perpendicular to the surface of the piezoelectric element 25, it is possible to efficiently transmit the impact force to the surface of the piezoelectric element 25. As a result, since the pressure-receiving position correction member 27 is suppressed from absorbing the impact force, it is possible to detect the impact force that has been absorbed by the object to be discriminated with a high precision. Also, since the viscoelastic member 26 and the pressure-receiving position correction member 27 are formed into films and cover the surface of the piezoelectric element 25, it is possible to protect the piezoelectric element 25.

In addition, the pressure-receiving position correction member 27 is formed of a member that is smaller in loss elastic modulus or loss tangent, and the viscoelastic member 26 is formed of a member that is larger in loss elastic modulus or loss tangent. The above structure makes it possible to extremely reduce the propagation of the impact force that has been received by the pressure-receiving position correction member 27 to the viscoelastic member 26. As a result, it is possible to improve a precision of the signal outputted from the piezoelectric element 25.

It is preferable that the roughness of the side surfaces of the pressure-receiving position correction member 27 and the viscoelastic member 26 in contact with each other is small. However, there is no limit of the amount of roughness. In the present invention, the side surfaces are not also limited to a surface having a linear slope shown in FIG. 4 but may be a curve surface.

Also, in order to discriminate the object to be discriminated, it is necessary to prepare the determination table in advance as described above. In the present invention, the thickness, the density, the kind, and the stiffness (for example, Gurley type stiffness), and the determination table may be created according to a purpose of the discrimination. It is needless to say that the determination table may conduct discrimination by setting a threshold value, or may conduct discrimination from a regression curve. According to the present invention, in a case where the impact forces that are different in strength are applied twice, the first strong impact force more strongly causes an influence of the density because a solid material is strongly compressed by the first strong impact force as compared with the second weak impact force. The second weak impact force more strongly causes an influence of deflection. For that reason, it is possible to create the determination table using the first and second detection signals on the axis of ordinate and the axis of abscissa, respectively.

### EXAMPLE 1

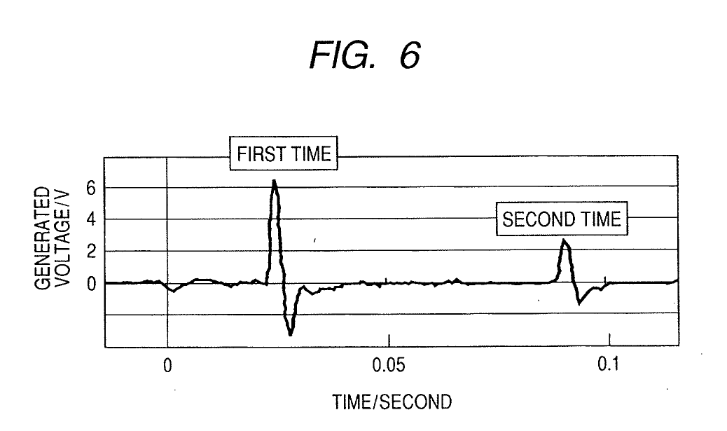

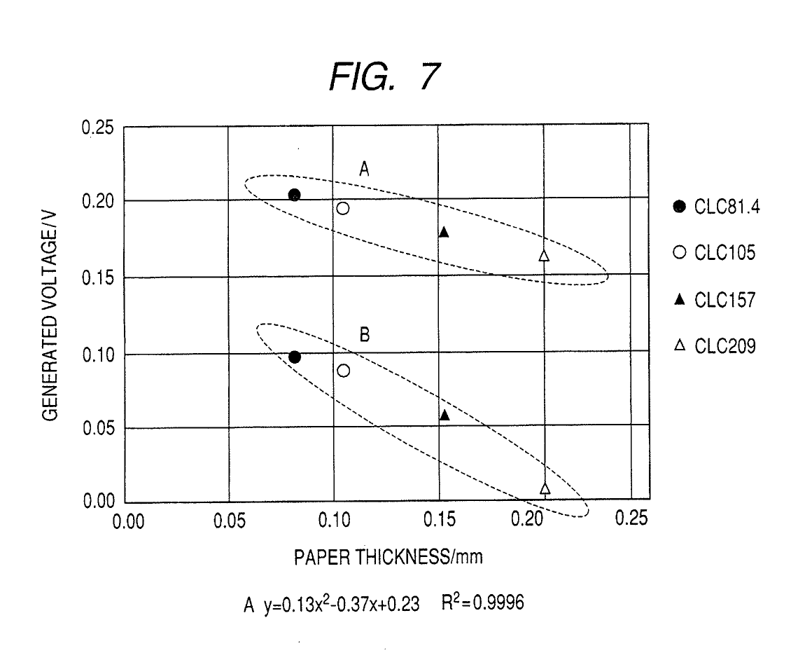

Subsequently, Example 1 according to the present invention will be described with reference to FIGS. 3 to 7. FIG. 6 is a timing chart showing an example of the generated voltage of the piezoelectric element at the time of applying an impact, and FIG. 7 is a diagram showing an example of the determination table.

As shown in a structure of FIG. 4, the impact force detection unit 20₁ according to the present invention is composed of a piezoelectric element 25, the viscoelectric members 26 and 28 that interpose the piezoelectric element 25 therebetween, and the pressure-receiving position correction member 27 embedded in the viscoelastic member 26. The overall shape of the impact force detection unit 20, is 5 mm in width, 10 mm in length, and 5 mm in height. The pressure-receiving position correction member 27 is attached to the center portion of the piezoelectric element 25 that detects the signal. According to this example, the pressure-receiving position correction member 27 is made of stainless steel and of a truncated cone-shape having an upper area of 5 mm in diameter and a lower area of 2 mm in diameter. The lower area of 2 mm in diameter is in contact with the piezoelectric element 25. The viscoelastic member 26 is made of silicone resin. The elastic modulus of stainless steel is 1.93×10⁶ N, and tan δ (loss tangent) is 0.002. Also, the elastic modulus of the silicone resins 26 and 28 is 5.5×10² N, and tan δ (loss tangent) is 0.15. The piezoelectric element 25 is formed by attaching a silver electrode onto the piezoelectric material PZT, and the overall shape of the piezoelectric element 25 is 5 mm in width, 10 mm in length, and 0.15 mm in height. The centers of the piezoelectric element 25 and the viscoelastic member 26 (pressure-receiving position correction member 27) are made to coincide with each other. The viscoelastic member 28 is made of nitrile rubber that is 80 in hardness, and 5 mm in width, 10 mm in length, and 2 mm in height. The signal output part installation table (hereinafter referred to as “installation table”) 23 is made of brass, and is 50 mm in length, 10 mm in width, and 4 mm in thickness. The signal output part installation table 23 can be attached at a predetermined position of the printer or the like by means of screw holes (not shown) or the like.

Also, as shown in FIG. 3, the impact force-applying member 12 is a round bar that is made of stainless steel and is 4 mm in diameter. A tip end of the impact force-applying member 12 has the radius of curvature of 50 mm in diameter, and the weight of the impact force-applying member 12 is 8.09 g. The impact force is applied to the sheet material 2 by means of the motor 13, the cam 15B, and the spring 18B. The strength of the impact force, the cycle, the number of repetitions, and the like may be arbitrarily set according to the shape of the cams or the motor driving control. According to the present invention, the impact forces of two times of 0.48 m/s and 0.23 m/s are applied during 0.1 seconds. The pressing members 16 and 17 of FIG. 3 are member for temporally fixing the sheet material. Each of the pressing members 16 and 17 is formed of a stainless round bar that is 4 mm in diameter, and a tip end of the pressing member has the radius of curvature of 50 mm in diameter in the present invention. The pressing members 16 and 17 are not essential for the discrimination apparatus 1, but prevent the variations (vibrations or the like) of the sheet material 2 in a case where the sheet material 2 is traveling.

On the other hand, FIG. 6 shows the results in the case where the impact force-applying member 12 arrives at the sheet material at the first time at a double speed as compared with a second time. FIG. 7 shows a case of the paper thickness of a CLC sheet (manufactured by Canon Inc.) which is an electrophotographic sheet as a specific example of one information within the determination table 55. FIG. 6 shows the generated voltages of the piezoelectric element in a case where the paper thicknesses of the CLC sheets that are different in grammage is represented on the axis of abscissa, and the relative generated voltages of the sheet material 2 on the basis of the voltage in a case where there is no intervention of the sheet material 2 are represented on the axis of ordinate. Also, the axis of abscissa represents the paper thickness of the respective sheets, and shows the average value obtained by measuring the respective 20 sheets at 10 portions per one sheet at random by using a micrometer. The sheets are measured while being transported at a speed of 20 cm/s.

The portion “A” surrounded by an oval of a broken line of FIG. 7 is the measurement result by the impact force application of the first time, and the portion “B” surrounded by an oval of a broken line of FIG. 7 is the measurement result by the impact force application of the second time. Assuming that the relative voltage is y, and the paper thickness is x, when the portions “A” and “B” are approximated by the quadratic function, the portion “A” can be represented by y=0.13x²−0.37x+0.23 (correlation coefficient R²=0.9996). The portion “B” can be returned by y=−4.13x²+0.42x+0.09 (correlation coefficient R²=0.9999). The paper thickness of unknown material can be determined by a voltage from the piezoelectric element by using the above regression curve. For example, it is assumed that the generated voltage is 0.20 V at the first time, and 0.10 V at the second time when the unknown recording sheet is transported at a speed of 20 cm/s. In this case, the thickness of paper is calculated as 76 μm at the first time, and 101 μm at the second time by the above regression function, and it is found that the average thickness of papers is 88.5 μm.

The information on the various sheet materials is provided in the determination table 55 in addition to the information on the thickness of paper of the above CLC sheet (manufactured by Canon Inc.), thereby making it possible to discriminate the kinds of various sheet materials. In other words, if the sheet material 2 has the paper thickness of the CLC sheet (manufactured by Canon Inc.), the output signal from the piezoelectric element 25 coincides with information shown in FIG. 7, and the sheet material 2 can be discriminated as the paper thickness of the CLC sheet (manufactured by Canon Inc.).

### Embodiment 2

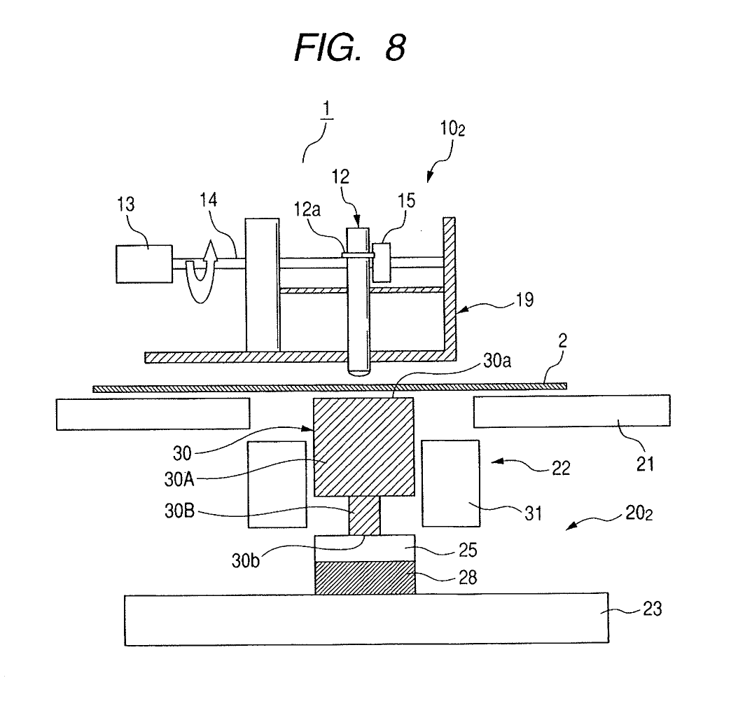

Subsequently, a description will be given of Embodiment 2 according the present invention, which partially modifies Embodiment 1. FIG. 8 is a structural diagram showing a discrimination apparatus according to Embodiment 2. In Embodiment 2, the same parts as those in Embodiment 1 are denoted by the same reference symbols, and their description will be omitted.

As shown in FIG. 8, a discrimination apparatus 1 according to Embodiment 2 is composed of an impact-applying unit 102 and an impact force detection unit 202. The impact applying unit 102 has no pressing members 16 and 17 (refer to FIG. 3) as compared with the impact-applying part 10, of Embodiment 1. Also, the discrimination apparatus 1 has no spring 18B for urging the impact-applying member 12, that is, applies the impact force by lifting the impact-applying member 12 using the cam 15 and then naturally dropping the impact-applying member 12.

A signal output part 22 of the impact force detection unit 202 includes a pressure-receiving position correction member 30 and a side guide member (side support member) 31 instead of the above pressure-receiving position correction member 27. The pressure-receiving position correction member 30 is composed of a large diameter member 30A having a large diameter columnar shape, and a small diameter member 30B having a columnar shape that is smaller in diameter than the large diameter member 30A. An upper surface 30a of the large diameter member 30A forms a pressure-receiving part for receiving the impact force, and a lower surface 30b of the small diameter member 30B forms an action part that acts the impact force on the piezoelectric element 25. The large diameter member 30A and the small diameter member 30B are integrally formed, and the lower surface 30b is adhered to the piezoelectric element 25 by, for example, an adhesive.

Also, the side guide member 31 has an inner peripheral part whose diameter is substantially equal to the outer diameter of the large diameter member 30A. In a case where the impact force is applied to the pressure-receiving position correction member 30, the side guide member 31 prevents the pressure-receiving position correction member 30 from being tilted. In addition, the side guide member 31 transmits a response from the sheet material 2 in the same direction (downward in the figure) as that of the impact force that has been applied. The pressure-receiving position correction member 30 and the side guide member 31 are so arranged as to coincide in the center line with the piezoelectric element 25.

The shape of the pressure-receiving position correction member 30 is not particularly limited, but may be columnar as shown in FIG. 8, or may be prismatic, conical, or pyramidal. Also, the pressure-receiving position correction member 30 is made of a metal material such as stainless steel or brass, ceramics such as alumina or zirconium, or an organic material such as Delrin. In addition, the material of the side guide member 31 is not particularly limited, but is desirably smaller in frictional coefficient with respect to the pressure-receiving position correction member 30 as much as possible. It is preferable that the side guide member 31 be made of a material different from that of the pressure-receiving position correction member 30. To be specific, the side guide member 31 may be formed of various bearings or a cylinder made of resin such as ABS or Teflon (registered trademark). Also, the viscoelastic member 28 is made of vibration proof material for separating the installation table 23 and the mechanical vibrations from each other, but is not always necessary. In addition, in FIG. 8, the upper surface of the sheet material installation table 21 and the upper surface 30a of the pressure-receiving position correction member 30 are on the same plane to be in contact with the sheet material 2 and the surfaces are flush. Alternatively, the upper surface 30a may be so arranged as to be lower than the upper surface of the sheet material installation table 21 so that the sheet material 2 is bent through application of the impact force.

As described above, according to the present invention, even if variations occur in the position of the received force corresponding to the impact application by the impact-applying unit 102, the impact force can be acted on a predetermined portion of the piezoelectric element 25 by the pressure-receiving position correction member 30. As a result, it is possible to improve a precision of the signal outputted from the piezoelectric element 25, and it is possible to improve the discrimination precision as the discrimination apparatus 1. In particular, even if a slight error occurs at the positions where the impact-applying unit 102 and the impact force detection unit 202 are located when the discrimination apparatus 1 is assembled to a printer or the like, it is possible to improve the precision of the signal outputted from the piezoelectric element 25. For that reason, it is possible to improve the discrimination precision as the discrimination apparatus 1 because the contents of the determination table 55 do not depend on the assembling error.

Also, since the side guide member 31 supports the sides of the pressure receiving position correction member 30, the side guide member 31 can prevent the pressure-receiving position correction member 30 from being tilted. Then, the transmission direction of the impact force is guided to a direction substantially perpendicular to the surface of the piezoelectric element 25, thereby making it possible to efficiently transmit the impact force to the surface of the piezoelectric element 25. As a result, the pressure-receiving position correction member 30 is prevented from absorbing the impact force, thereby making it possible to detect the impact force that has been absorbed by the object to be discriminated with a high precision.

In addition, the pressure-receiving position correction member 30 is formed of a member that is small in loss elastic modulus or loss tangent, and guided by the side guide member 31 in a direction along which the impact force is applied. For that reason, the impact force that has been received by the pressure-receiving position correction member 30 is efficiently transmitted (without being absorbed by other members). As a result, it is possible to improve the precision of the signal outputted from the piezoelectric element 25.

### EXAMPLE 2

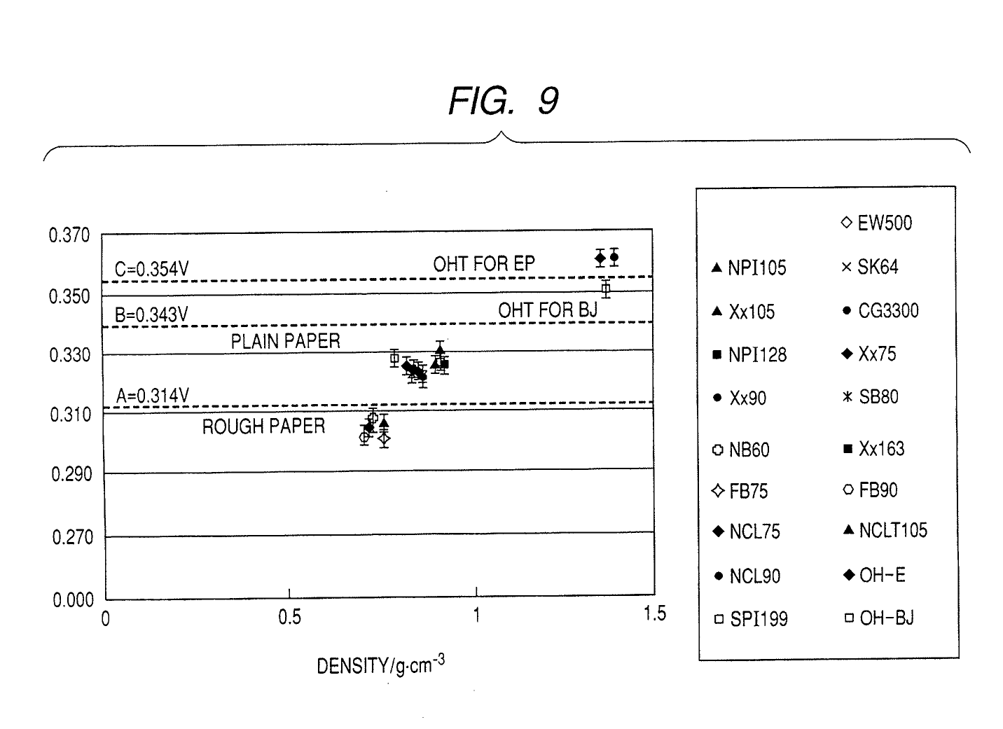

Subsequently, Example 2 of the present invention will be described with reference to FIGS. 8 and 9. FIG. 9 is a diagram showing a relationship between densities of respective sheet materials and relative generated voltages from the piezoelectric element.

The impact force applying member 12 is made of stainless steel which is 8 g in weight and 3.5 mm in diameter. Also, the piezoelectric element 25 is 4 mm in width, 10 mm in length, and 0.13 mm in height. The pressure-receiving position correction member 30 is made of stainless steel and composed of cylindrical columns of a large diameter member 30A that is 10 mm in diameter and a small diameter member 30B that is 2 mm in diameter. Further, the side guide member 31 is formed of a cylinder made of Teflon (registered trademark) resin. The viscoelastic member 28 is made of silicone rubber that is 90 in hardness, and the signal output part installation table 23 is a stainless steel table.

In this example, an impact force was applied to a printer recording sheet at a speed of 0.23 m/s by the impact-applying member 12. Used for sheets were EW500, SK64, OH-E, and OH-BJ which are manufactured by Canon Inc., NPI105 manufactured by Nippon Paper Industries Co., Ltd., CG3300 manufactured by Sumitomo 3M Limited, Xx75, Xx105, and Xx165 which are manufactured by Fuji Xerox Co., Ltd., NB60, NCL75, and NCL105 which are manufactured by Neenah Paper Inc., FB90 and FB75 which are manufactured by Fox River Company, and SPI99 manufactured by International Paper Company. Those are normally classified as a plain paper, a rough paper, and an OHT paper. The NPI105, NPI128, Xx75, Xx105, Xx163, SPI199, EW500, and SK64 correspond to plain papers. The OH-E and CG3300 correspond to electrophotographic OHT, and the OH-BJ corresponds to an ink jet OHT. Other sheets are classified as the rough paper.

For those sheets, the weight and thickness of 10 sheets of A4 size were measured, and the densities of the respective sheets were calculated. Generated voltages from the piezoelectric element 25 were plotted with the axis of ordinate representative of a relative voltage based on a value when there is no sheet and with the axis of abscissa representative of the density of the recording sheet. FIG. 9 shows the results. The figure is a determination table for classifying the rough paper, the plain paper, the ink jet OHT, and the electrophotographic OHT. With respect to the unknown materials, it is possible to discriminate the rough paper, the plain paper, the ink jet OHT (OH-BJ), and the electrophotographic OHT (OH-E) sheet by using three threshold voltages of A (=0.314 V), B (=0.343 V), and C (=0.354 V) of FIG. 9.

As described above, those sheets can be classified into the categories such as the plain paper or the rough paper regardless of makers or model numbers. In addition, with respect to the electrophotographic and ink jet OHT papers, it was found that the different relative generated voltages could be observed by the discriminated device 1 of the present invention. In other words, in FIG. 9, the three threshold values A, B, and C are set with respect to the relative generated voltage by the discrimination apparatus 1 of the present invention, thereby making it possible to classify the sheets as follows. The sheet is the rough paper when the generated voltage is A=0.314 V or lower, the plain paper when the voltage is between B=0.343 V and A=0.314 V, the ink jet OHT when the voltage is between C=0.354 V and B=0.343 V, and the electrophotographic OHT when the voltage is C=0.354 V or higher.

In general, in a copying machine or a printer of an electrophotographic recording system, there has been known that the image forming conditions are changed based on the kind of recording sheets to be used. On the contrary, according to the discrimination apparatus of the present invention, the determination table shown in FIG. 9 is provided, thereby making it possible to discriminate the unknown recording sheets as the plain paper, the rough paper or the OHT. Also, in FIG. 9, since the correlation of the linear relationship is found in the density and the relative generated voltage, it is possible to roughly estimate the density of the unknown recording sheet.

In the above-described discrimination apparatus 1, when the impact force-applying member 12 is deviated from the center of the center line 6 of the pressure-receiving position correction member 30 by 2 mm or less, a fluctuation of the relative generated voltage is within 0.01%, when deviated by 2 to 4 mm, the fluctuation is within 0.08%, and when deviated by 4 to 4.5 mm, the fluctuation is within 0.18%. Then, it was confirmed that the output signal from the piezoelectric element 25 was extremely stabilized by the pressure-receiving position correction member 30 and the side guide member 31.

In Embodiments 1 and 2, the discrimination apparatus 1 is used in the image forming apparatus such as a printer, the kind of sheet material is discriminated as an object to be discriminated. However, the present invention is not limited to the above sheet material, but any object to be discriminated and any apparatus for which the discrimination result is used fall within the scope of the present invention.

Further, a case where, the impact-applying unit and the signal output part are separately formed and the error in the relative position occurs at the time of assembling has been described as an example. However, even in the discrimination apparatus in which the relative position of the impact-applying unit and the signal output part is fixed by, for example, the arm member, that is, the impact-applying unit and the signal output part are integrally related to each other, the present invention is effective for the discrimination apparatus in which the position is deviated at the time of applying impact by the impact-applying member.

According to the present invention, even if a variation occurs at the position of the force received corresponding to the impact application of the impact-applying unit, the impact can be acted on the predetermined portion of the signal output unit. As a result, it is possible to improve the precision of the signal outputted from the signal output unit, and it is possible to improve the discrimination precision as the discrimination apparatus.

This application claims priority from Japanese Patent Application No. 2005-165795 filed Jun. 6, 2005, which is hereby incorporated by reference herein.

What is claimed is:

1. A discrimination apparatus comprising:
an impact-applying unit for applying an impact to an object to be discriminated;
a signal output unit for outputting a signal corresponding to an impact applied by the impact-applying unit;
a discrimination unit for discriminating the object to be discriminated on a basis of the signal from the signal output unit; and
a pressure-receiving position correction member comprising a pressure-receiving part for receiving an impact force applied by the impact-applying unit, and an action part for acting the impact force received at the pressure-receiving part on a predetermined site of the signal output unit, the action part having an area smaller than an area of the pressure-receiving part.

2. A discrimination apparatus according to claim 1, wherein the discrimination unit has reference information for discriminating the object to be discriminated in advance, and discriminates the object to be discriminated on a basis of the reference information and the signal from the signal output unit, and wherein the impact-applying unit and the signal output unit are separately structured and disposed opposite to each other so that the object to be discriminated is interposed between the impact-applying unit and the signal output unit when the impact is applied by the impact application unit.

3. A discrimination apparatus according to claim 1, wherein the pressure-receiving part and the action part of the pressure-receiving position correction member are formed so as to have planar shapes parallel to each other, and wherein the impact-applying unit applies an impact in a direction substantially perpendicular to the pressure-receiving part.

4. A discrimination apparatus according to claim 1, wherein the pressure-receiving position correction member is formed of a member having a small elastic modulus or loss tangent.

5. A discrimination apparatus according to claim 1, further comprising a side support member for supporting the pressure-receiving position correction member from a side thereof with respect to a direction in which the force received at the pressure-receiving part is acted through the action part of the pressure-receiving position correction member.

6. A discrimination apparatus according to claim 5, wherein the side support member is formed into a film shape having a fitting hole into which the pressure-receiving position correction member is fitted and is formed of a member having a larger loss elastic modulus or loss tangent than that of the pressure-receiving position correction member, and a layer for covering a surface of the signal output unit is formed by the pressure-receiving position correction member and the side support member.

7. A discrimination apparatus according to claim 5, wherein the pressure-receiving position correction member is composed of a columnar member having a larger diameter and a columnar member having a smaller diameter than the larger diameter, the members being connected to each other through respective circular plane portions thereof, and wherein the side support member slidably supports an outer peripheral side surface of the member having the large diameter.

8. A discrimination apparatus according to claim 1, wherein the signal output unit includes a mechano-electrical transducer.

9. A discrimination apparatus according to claim 1, wherein the object to be discriminated comprises a sheet material formed in a sheet shape, and wherein the discrimination unit discriminates a kind of sheet material.

10. A signal output apparatus for outputting a signal corresponding to an impact application, comprising:
a mechano-electrical transducer;
a pressure-receiving part for receiving an impact force; and
an action part for acting a force received at the pressure-receiving part on the mechano-electrical transducer, action part having an area smaller than an area of the pressure-receiving part.
